(19) United States
(12) Patent Application Publication
(10) Pub. No.: US 2011/0108203 A1
(43) Pub. Date: May 12, 2011

(54) Apparatus for Stripping Metal From a Cathode Plate

(75) Inventor: Per Ola Eriksson, Queensland (AU)

(73) Assignee: Xstrata Technology Pty Ltd., Brisbane (AU)

(21) Appl. No.: 12/671,538

(22) PCT Filed: Jul. 31, 2008
(86) PCT No.: PCT/AU2008/001107

§ 371 Date: Mar. 2, 2010

(30) Foreign Application Priority Data
Aug. 7, 2007 (AU) 2007904244

(51) Int. Cl. B32B 43/00

(52) U.S. Cl. 156/701; 156/759; 156/760

(57) ABSTRACT

An apparatus for stripping metal from a cathode plate in which part of the metal has been separated from the cathode plate to form a gap between the part of the metal and the cathode plate, the apparatus comprising at least one roller for positioning in the gap between the metal and the cathode plate and drive means for driving the roller along the cathode plate or the metal to cause stripping of the metal from the cathode plate.

### FIELD OF THE INVENTION

The present invention relates to an apparatus for stripping metal from a cathode plate. The present invention also relates to a method for stripping metal from a cathode plate.

### BACKGROUND TO THE INVENTION

Production of metal using electrochemical processes involves deposition of the metal on a cathode plate. A number of different metals may be obtained using such processes, including copper, nickel, zinc, cobalt and so on. For example, in the electrowinning or electrorefining of copper, copper metal is deposited on to stainless steel cathode plates. When the deposited copper metal has grown to a desired thickness, the cathode plate is removed from the electrolysis cell and the deposited metal is stripped from the cathode plate.

Stripping of the deposited metal from the cathode plate is desirably conducted using a largely automated process in order to achieve high throughput in the stripping plant. For example, in U.S. Pat. No. 4,840,710, the entire contents of which are incorporated herein by cross-reference, a method for stripping electrically deposited copper from a cathode is described. In this method, the cathode is flexed by an amount exceeding the strength of the adhesion bond between the deposited metal and the cathode; but not exceeding the elastic limit of the cathode. This causes at least part of the deposited metal to separate from the cathode, leaving a gap between that part of the deposited metal and the cathode. The deposited metal is then stripped from the cathode by use of wedges that slide along the surface of the cathode and the deposited metal. U.S. Pat. No. 4,840,710 also describes the use of gas blasting to strip the deposited metal from the cathode.

The method of U.S. Pat. No. 4,840,710 has been commercially implemented in a number of copper plants around the world and this method forms part of the ISA PROCESS™ technology commercially available from the present applicant.

When metal is deposited on cathode plates, edge strips are typically placed on the vertical edges of the cathode plates in order to prevent metal being deposited along the vertical or side edges of the cathode plates. As a result, sheets of metal are deposited on either side of the cathode plate. These sheets of metal on either side of the cathode plate are not joined to each other along their vertical edges.

In some plants, the bottom edge of the cathode plates are covered in wax or fitted with bottom strips prior to deposition of metal thereon. This prevents the deposition of metal along the bottom edge of the cathode plates and, consequently, the sheets of metal that are deposited on either side of cathode plate remain separate from each other.

In other plants, the bottom edge of the cathode plates are not waxed or fitted with bottom strips prior to deposition of metal, which results in metal also being deposited along the bottom edge of the cathode plate. In these plants, the sheets of deposited metal on either side of the cathode plate are connected to each other by the metal that is deposited along the bottom edge. During stripping of cathodes in which metal is deposited along the bottom edge as well as on either side of the cathode plate, the wedges push the sheets of metal away from the sides of the cathode plate out to grippers, to an approximate angle of 15-20 degrees. The grippers then bring the copper to the horizontal position and pulls it for separation.

However, if the metal that has deposited on the bottom edge of the cathode plate does not break during the initial stripping operation, it is necessary to flex the sheets upwardly and then downwardly until that metal does break. In order to achieve this, some stripping plants are provided with grippers that grip the sheets of metal in the event that the interconnecting metal does not break. The grippers are then used to flex the sheets of metal upwardly and downwardly until the interconnecting metal between the sheets does break.

Throughout this specification, the term “comprising” and its grammatical equivalents shall be taken to have an inclusive meaning unless the context of use clearly indicates otherwise.

### BRIEF DESCRIPTION OF THE INVENTION

It is an object of the present invention to provide an apparatus and a method that overcomes or at least ameliorates one or more of the disadvantages of the prior art, or least provides a commercially acceptable alternative.

In a first aspect, the present invention provides an apparatus for stripping metal from a cathode plate in which part of the metal has been separated from the cathode plate to form a gap between the part of the metal and the cathode plate, the apparatus comprising at least one roller for positioning in the gap between the metal in the cathode plate and drive means for driving the roller along the cathode plate or the metal to cause stripping of the metal from the cathode plate.

The metal that is to be stripped from the cathode plate may be two sheets that are not joined in any manner, or they may be attached by a weak join at the bottom of the plate.

The orientation of the cathode plate is normally with the bottom of the cathode facing the bottom, and the hanger bar at the top. However the cathode can be stripped with the hanger bar at the bottom and the bottom of the cathode facing upwards. Alternatively, the cathode could be stripped at any angle in between.

The cathode in the stripping operation can be supported by the hanger bar, the bottom of the cathode plate, or a combination there of.

The at least one roller may comprise a stand alone roller. Alternatively, the at least one roller may form part of a larger structure. For example, the at least one roller may be mounted inside a housing or a body, with a part of the roller coming into contact with the cathode plate or the metal and the housing or body coming into contact with the other of the cathode plate or the metal. The at least one roller may be a wheel.

It will be appreciated that the at least one roller is positioned between the cathode plate and the metal that has been deposited on the cathode plate. Consequently, when the drive means is actuated to drive the roller along the cathode plate or the metal (or both), the at least one roller pushes the metal away from the cathode plate to thereby strip the metal from the cathode plate.

It is preferred that the apparatus includes at least one roller on one or both sides of the cathode plate for positioning in the gap between the metal and the cathode plate.

In some embodiments, the apparatus may comprise at least two rollers positioned on one or both sides of the cathode plate, with one of the least two rollers being in contact with the cathode plate and one of the at least two rollers being in contact with the metal.

In this embodiment, the rollers that are in contact with the cathode plate act to locate and guide the rollers whilst the rollers that are in contact with the metal act to force the metal away from the cathode plate as the drive means is operated to drive the rollers along the cathode plate. Suitably, the at least two rollers are mounted in fixed relationship to each other.

The rollers may comprise any suitable rollers. For example, the rollers may be metal rollers, they may be made from an elastomeric or polymeric material or they may have an elastomeric or polymeric coating thereon.

In embodiments of the present invention where the bottom edge of the cathode plate is not treated to prevent metal being deposited thereon, one or more further rollers located externally to the deposited metal may be provided. The external rollers may be brought into contact with the external surface of the sheets of metal in the event that the interconnecting metal between the sheets of metal does not break during stripping. The external rollers may then be used to flex the sheets of metal upwardly to assist in breaking the interconnecting metal.

In some instances, the external rollers may be arranged such that they move in concert with the stripping rollers. For example, the external rollers may be mounted to a cradle that also mounts the stripping rollers. In this embodiment, the external rollers may be biased, such as by spring loading or other mechanisms, so that the external rollers remain in contact with the outside surface of the metal being stripped. In this embodiment, the external rollers act to support the sheets of metal that are being stripped from the cathode plate during the stripping operation. This can allow for improved handling of the stripped metal sheets. Further, should any interconnecting metal between the sheets of metal not break during initial stripping, the drive mechanism can be actuated to raise the roller assemblies. As the external rollers are in contact with the external surface of the metal sheets, this causes the metal sheets to flex upwardly. Therefore, flexing of the metal sheets in the upwards and downwards direction can be easily achieved should the interconnecting metal not break during initial stripping.

In other embodiments, the external rollers may be operated independently to the stripping rollers

In a second aspect, the present invention provides a method for stripping metal from a cathode plate comprising the steps of causing at least part of the metal to separate from the cathode plate and form a gap between the cathode plate and the metal, positioning at least one roller in the gap between the metal and the cathode plate and moving the at least one roller along the cathode plate or the metal to thereby strip the metal from the cathode plate.

In the method of the second aspect of the present invention, the method may include the step of flexing the cathode plate to cause at least part of the metal to separate from the cathode plate.

The invention of the first and second aspects of the present invention provides a number of significant benefits when compared with existing apparatus and methods for stripping deposited metal from cathode plates. In particular, capital costs are lower and maintenance requirements are decreased. As maintenance requirements are decreased, downtime in the cathode stripping plant is also decreased, thereby allowing for higher capacity and higher availability in the cathode stripping plant. Furthermore, as rollers are used to separate the deposited metal from the cathode plates, less damage is done to the cathode plates and to the metal being stripped from the cathode plates.

The present invention also encompasses a stripping apparatus in which the grippers that are used to grip the metal in present stripping plants are replaced with one or more rollers that come into contact with the external surface of the metal in the event that any interconnecting metal between the sheets of metal do not break during initial stripping.

Accordingly, in a third aspect, the present invention provides an apparatus for stripping metal from a cathode plate in which a sheet of metal is deposited on either side of the cathode plate and interconnecting metal that forms a bridge between the sheets of metal on either side of the cathode plate is deposited along the bottom edge of the cathode plate, the apparatus comprising stripping means for separating the sheets of metal on either side of the cathode plate from the cathode plate and one or more rollers that come into contact with an external surface of the sheets of metal and push the sheets of metal to thereby cause the sheets of metal to flex about the interconnecting metal in the event that the interconnecting metal does not break during stripping.

In the third aspect of the present invention, the one or more rollers may be moved into contact with the external surface of the sheets of metal if the interconnecting metal does not break during initial stripping. In another embodiment, the one or more rollers that come into contact with the external surface of the sheets of metal may be placed in contact with the external surfaces of the sheets of metal during initial stripping.

In a fourth aspect, the present invention provides a method for stripping metal from a cathode plate in which a sheet of metal is deposited on either side of the cathode plate and interconnecting metal that forms a bridge between the sheets of metal on either side of the cathode plate is deposited along the bottom edge of the cathode plate, the method comprising the steps of causing at least a part of the deposited sheets of metal to separate from the cathode plate, stripping the sheets of metal from the cathode plate and, in the event that the interconnecting metal does not break during initial stripping, pushing the sheets of metal towards each other by means of one or more rollers placed in contact with an external surface of the sheets of metal.

In the method of the fourth aspect of the present invention, the method may include the step of flexing the cathode plate to cause at least part of the metal to separate from the cathode plate.

In all aspects of the present invention, a flexing station, which flexes the cathodes prior to stripping of the metal sheets from the cathodes, will be provided. The flexing station flexes the cathodes and breaks the adhesion bond between the cathode and at least part of the metal. This may be achieved, for example, in accordance with the method described in U.S. Pat. No. 4,840,710, or by using a stripping element that is turnably moveable in the vertical direction of the cathode as described in PCT/FI2004/000719 (WO 2005/054546 A1). Any other flexing operation known to the person skilled in the art or described in the literature may also be used to form the gaps.

In order to maintain the gap between the cathode plate and the metal, one or more wedges may be inserted between the metal and the cathode plate. An example in this regard is given in FIGS. 12 and 13 of Australian patent number 625243. Alternatively, one or more arms may be inserted between the metal and the cathode plate and the arms pulled away slightly from the cathode plate to maintain the gap between the metal and the cathode plate.

The present invention may be used in both the electrowinning and electro-refining plants. It has been found that, in plants where the bottom edge of the cathode plate is not protected against electrodeposition of metal and therefore an interconnecting bridge of metal is deposited on the bottom edge, the interconnecting metal tends to break more easily in the electrowinning plants then in electrorefining plants due to process differences.

### BRIEF DESCRIPTION OF THE DRAWINGS

FIG. 1 shows a schematic end view of a stripping apparatus in accordance with the present invention;

FIG. 2 shows a schematic end view similar to that shown in FIG. 1, but with the stripping rollers moved part way along the cathode plate;

FIG. 3 shows a schematic end view is similar to that shown in FIG. 2 but with the stripping rollers moved even further along the cathode plate;

FIG. 4 shows a schematic end view similar to that shown in FIG. 3 but with the stripping rollers moved along the full extent of movement along the cathode plate;

FIG. 5 shows a schematic end view of the stripping operation in which the interconnecting metal that was deposited on the bottom edge of the cathode plate was not broken by the initial stripping operation; and

FIG. 6 shows a schematic end view similar to that shown in FIG. 5 but with the external rollers being used to flex the sheets of metal upwardly about the interconnecting metal.

### DETAILED DESCRIPTION OF THE DRAWINGS

It will be understood that the drawings accompanying this specification have been provided for the purposes of illustrating preferred embodiments of the present invention. Thus, it will be understood that the present invention should not be considered to be limited to the features as shown in the drawings.

FIG. 1 shows a cathode plate 10 having sheets of metal 12, 14 deposited on either side and thereof. The cathode plate 10 includes a cathode hangar 11, as will be well understood by the person skilled in the art.

As shown in FIG. 1, gaps have been formed between the cathode plate 10 and their respective sheets of metal 12, 14. These gaps are denoted by reference numerals 16, 18. The gaps 16, 18 may be formed by flexing of the cathode in a flexing station. This may be achieved, for example, in accordance with the method described in U.S. Pat. No. 4,840,710, or by using a stripping element that is turnably moveable in the vertical direction of the cathode as described in PCT/FI2004/000719 (WO 2005/054546 A1). Any other flexing operation known to the person skilled in the art or described in the literature may also be used to form the gaps. The gaps may be maintained by using wedges or arms that are positioned between the sheets of metal and the cathode plate in the flexing station. An example in this regard is given in FIGS. 12 and 13 of Australian patent number 625243.

In order to strip the metal from the cathode plate, stripping rollers are provided. As shown in FIG. 1, the stripping rollers include first roller 20 and second roller 22 that are positioned in the gap between the cathode plate 10 and in the sheet of metal 12. Similarly, on the other side of the cathode plate, stripping rollers are also provided. The stripping rollers on the other side of the cathode plate include first roller 24 and the second roller 26. The first rollers 20 and 24 come into contact with the cathode plate. The second rollers 22 and 26 are positioned outwardly from the first rollers 20, 24 and, as a result, the second rollers 22, 26 come into contact with the inner surface of the respective sheets of metal 12, 14.

Although not shown in FIG. 1, the stripping apparatus also includes a drive means that is used to drive the rollers along the cathode plate. The drive means may comprise a pneumatic drive means, a hydraulic drive means, a machine driven drive means, an electric motor drive means or a gear driven drive means In one embodiment, the drive means comprises one or more pneumatic rams that can be extended to drive the rollers downwardly and retracted to move the rollers upwardly.

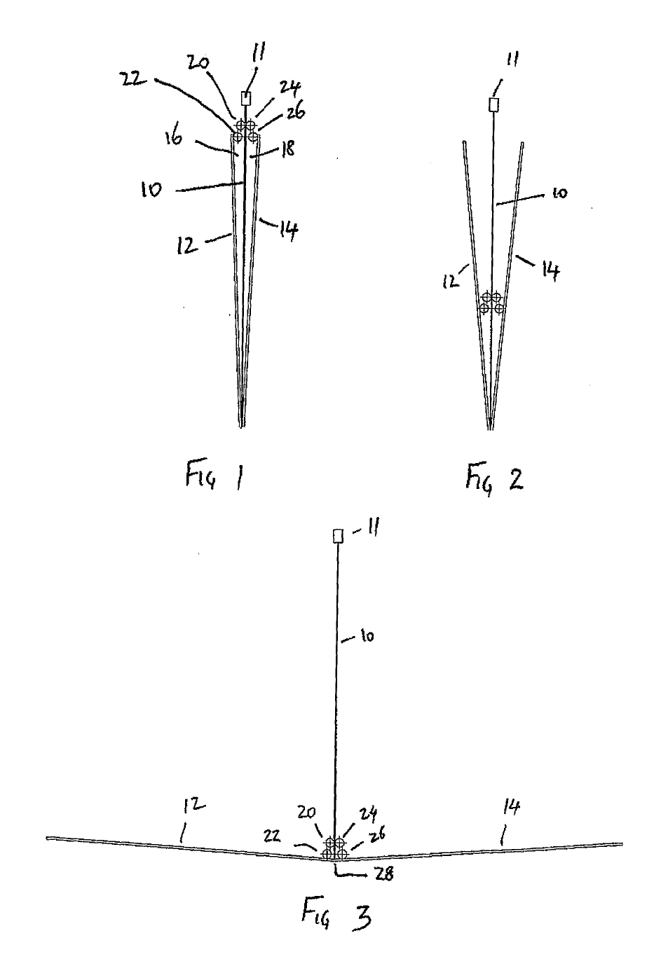

In FIG. 2, the drive means have been operated to move the rollers downwardly along the cathode plate 10. As can be seen from FIG. 2, as the rollers move downwardly along the cathode plate, the sheets of metal 12, 14 are progressively pushed further away from the cathode plate 10.

FIG. 3 shows the orientation of the sheets of metal 12, 14 when the rollers have moved to almost the full extent of travel along the cathode plate 10. As can be seen from FIG. 3, the sheets of metal 12, 14 have been essentially stripped from the cathode plate 10. However, the sheets of metal 12, 14 are connected to each other by a bridge 28 of interconnecting metal that is formed by electrodeposition on the bottom edge of the cathode plate. It is necessary to break this bridge of metal 28.

The connection point between the two copper deposits at the bottom is sometimes very strong and a lot of force is required to downend the copper. As the grippers that are used in currently available stripping apparatus are attached to the metal approximately halfway up the sides of the metal, the metal deposits sometimes bends between the grippers and the bottom during the down motion. The rollers in the present invention are closer to the connection point at the bottom when forcing the copper outwards. This means that there is less chance of bending the metal deposits (as the fulcrum is closer to joint) and the forces applied are more directed in to the supposed break point at the v-groove that may be formed in the metal that is deposited at the bottom edge of the cathode plate.

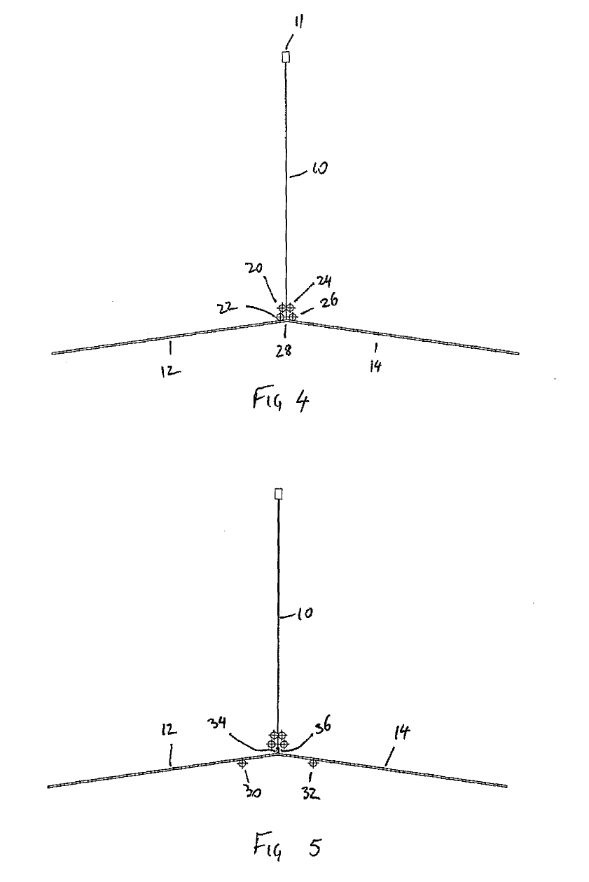

FIG. 4 shows the rollers being moved to their lowermost orientation, which represents the full extent of travel along the cathode plate 10. As can be seen from FIG. 4, the cathode plates 12, 14 have been pushed beyond horizontal. This assists in breaking the interconnecting bridge of metal 28.

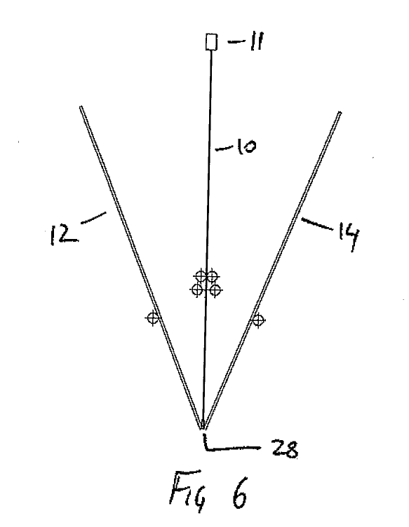

In the event that the interconnecting bridge of metal 28 does not break during the initial stripping steps as shown in FIGS. 1 to 4, it may be necessary to flex the sheets of metal 12, 14 about the interconnecting bridge 28 in order to break the interconnecting bridge 28. In order to achieve this flexing, external rollers 30 and 32 may be brought into contact with the external surfaces of sheets of metal 12, 14 (see FIG. 5). Furthermore, supports 34, 36 may be brought into contact with the inner surfaces of the metal sheets 12, 14 near the bottom of the cathode plate 10 in order to stop the metal sheets moving vertically upwards and impacting on the cathode plate 10. The external rollers 30, 32 may then be moved upwardly, as is shown in FIG. 6, to thereby cause the metal sheets 12 and 14 to flex about the interconnecting bridge 28. If this operation is not sufficient to break the metal in the interconnecting bridge, the stripping rollers may again be used to flex the sheets of metal downwardly. The upwards and downwards flexing of the sheets of metal will continue until the interconnecting bridge 28 actually breaks.

The external rollers 30, 32 that are shown in FIGS. 5 and 6 may be arranged so that they travel in concert with the stripping rollers 20, 22, 24, 26. For example, the external rollers 30 and 32 may be mounted to make common mounting with the stripping rollers. The external rollers may be spring-loaded so that they remain in contact with the external face of the metal sheets 12, 14.

In another embodiment, the external rollers 30, 32 may move separately to the stripping rollers.

It will also be understood that the external rollers may be utilised with other stripping apparatus, such as wedge strippers or gas blast strippers.

Those skilled in the art will understand that the present invention may be susceptible to variations and modifications other than those specifically described. It will be understood that the present invention encompasses all such variations and modifications that fall within its spirit and scope.

1. An apparatus for stripping metal from a cathode plate in which part of the metal has been separated from the cathode plate to form a gap between the part of the metal and the cathode plate, the apparatus comprising at least one roller for positioning in the gap between the metal and the cathode plate and drive means for driving the at least one roller between the cathode plate and the metal in contact with an internal surface of the metal to cause stripping of the metal from the cathode plate, and one or more external rollers adapted to contact an external surface of the metal.

2. The apparatus according to claim 1 wherein the at least one roller is mounted inside a housing or body.

3. The apparatus according to claim 1 wherein the apparatus comprises at least one roller on one or both sides of the cathode plate for positioning in the gap between the metal and the cathode plate.

4. The apparatus according to claim 1 wherein the apparatus comprises at least two rollers positioned on one or both sides of the cathode plate, wherein one of the at least two rollers is in contact with the cathode plate and one of the at least two rollers is in contact with the metal.

5. The apparatus according to claim 4 wherein the at least two rollers are mounted in fixed relationship to one another.

6. The apparatus according to claim 1 wherein the one or more external rollers are adapted to move in concert with the at least one roller.

7. The apparatus according to claim 1 wherein the one or more external rollers are adapted to move independently of the at least one roller.

8. A method for stripping metal from a cathode plate comprising the steps of causing at least part of the deposited metal to separate from the cathode plate and form a gap between the cathode plate and the metal, positioning at least one roller in the gap between the deposited metal and the cathode plate, moving the at least one roller between the cathode plate and the metal in contact with an internal surface of the metal to thereby strip the metal from the cathode plate and positioning one or more external rollers in contact with an external surface of the metal.

9. The method according to claim 8 comprising the additional step of flexing the cathode plate to cause at least part of the metal to separate from the cathode plate.

10. An apparatus for stripping metal from a cathode plate in which a sheet of metal is deposited on either side of the cathode plate and interconnecting metal that forms a bridge between the sheets of metal on either side of the cathode plate is deposited along the bottom edge of the cathode plate, the apparatus comprising stripping means for separating the sheets of metal on either side of the cathode plate from the cathode plate, the stripping means including one or more rollers positioned in a gap between the metal and the cathode plate and one or more external rollers that come into contact with an external surface of the sheets of metal and push the sheets of metal to thereby cause the sheets of metal to flex about the interconnecting metal when the interconnecting metal does not break during stripping.

11. The apparatus according to claim 10 wherein the apparatus comprises one or more rollers on both sides of the cathode plate for positioning in the gap between the metal and the cathode plate.

12. The apparatus according to claim 10 wherein the apparatus comprises at least two rollers positioned on one or both sides of the cathode plate, wherein one of the at least two rollers is in contact with the cathode plate and one of the at least two rollers is in contact with the metal.

13. The apparatus according to claim 12 wherein the at least two rollers are mounted in fixed relationship to one another.

14. The apparatus according to claim 10 wherein the one or more external rollers are moved into contact with the external surface of the sheets of metal if the interconnecting metal does not break during initial stripping.

15. The apparatus according to claim 10 wherein the one or more external rollers are moved into contact with the external surface of the sheets of metal during initial stripping.

16. A method for stripping metal from a cathode plate in which a sheet of metal is deposited on either side of the cathode plate and interconnecting metal that forms a bridge between the sheets of metal on either side of the cathode plate is deposited along the bottom edge of the cathode plate, the method comprising the steps of causing at least a part of the deposited sheets of metal to separate from the cathode plate by driving at least one roller between the cathode plate and the metal in contact with an internal surface of the metal, stripping the sheets of metal from the cathode plate and, when the interconnecting metal does not break during initial stripping, flexing of the sheets of metal towards each other by means of one or more rollers placed in contact with an external surface of the sheets of metal.

17. The method according to claim 16 wherein the method comprises the additional step of flexing the cathode plate to cause at least part of the metal to separate from the cathode plate.
